(19) United States
(12) Patent Application Publication
(10) Pub. No.: US 2007/0156518 A1
(43) Pub. Date: Jul. 5, 2007

(54) Invoice verification hub

(76) Inventors: Paola Sala, Heidelberg (DE); Robert Reiner, Kirrlach (DE)

Correspondence Address: Schwegman, Lundberg, Woessner & Kluth, P.A., P.O. Box 2938, Minneapolis, MN, 55402, US

(21) Appl. No.: 11/322,326

(22) Filed: Dec. 30, 2005

(51) Int. Cl. G07G 1/14

(52) U.S. Cl. 705/14

(57) ABSTRACT

A system includes a first business object including a first source of information, a second business object including a second source of information, and a hub operatively connected to the first business object and the second business object. The system also includes an information checking mechanism for comparing information from the first source and information from the second source with information from a third source. A method of checking invoices includes populating a local invoice due list with invoice information from distributed components as transactions occur, and checking an invoice against the local invoice due list.

### BACKGROUND

In complex business management systems, transactions may be handled by many different parts of the system. Operations components of systems may be responsible for receiving orders, shipping, checking invoices, tracking payments and providing information to an accounting system. In some systems, the accounting function may be separate from the operations components. Such systems can be very complex, and it is difficult to track business transactions that may flow through the system.

### BRIEF DESCRIPTION OF THE DRAWINGS

FIG. 1 is a block diagram of an overall computing environment, according to an example embodiment.

FIG. 2 is a display of a model of a business object, according to an example embodiment.

FIG. 3 is a schematic view of a portion of the computing environment that includes a hub, according to an example embodiment.

FIG. 4 is a block diagram illustration of a value chain with prima nota and single point inventory objects, according to an example embodiment.

FIG. 5 is a flow diagram of a method for checking invoices, according to an example embodiment.

FIG. 6 is a schematic of a computer system that executes programming, according to an example embodiment.

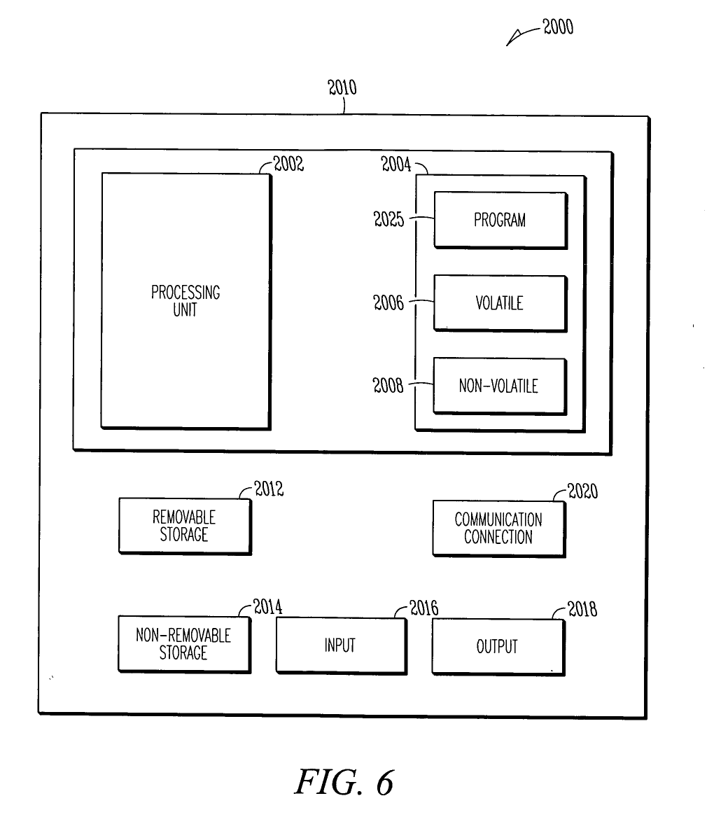

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

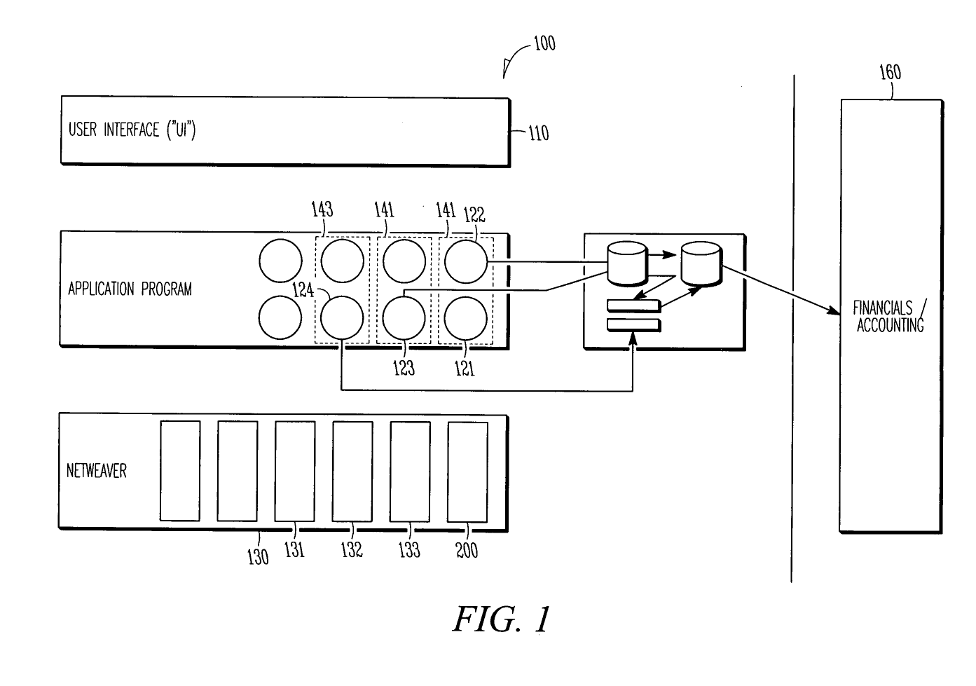

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123, 124. The object is a technical representation of a concept that includes data and logic. In one example embodiment, the object, such as object 121, 122, 123, 124 is referred to as a business object and is a technical representation of a business concept that includes data and logic. As shown, the business objects 121, 122, 123, 124 can be grouped into logical deployment units, such as logical deployment unit 141, 142, 143. A logical deployment unit is a grouping of business objects that perform tasks related to a function. As shown, the system also includes a hub 300 and a financial and accounting component 160. A first business object 122 and a second business object 123 are connected to one portion of the hub 300. A third business object 124 is connected to another portion of the hub 300. The hub 300 is also connected to the financial and accounting component 160. There is a line between the financial and accounting component 160 which denotes that this component is separated from the business objects 121, 122, 123, 124. The hub 300 has one or many interfaces to the accounting and financial component 160. The system 100 includes a first business object 122 including a first source of information, a second business object 123 including a second source of information, and a hub 300 operatively connected to the first business object 122 and the second business object 123. The hub 300 collects information from the first source and the second source of information. The hub 300 is also operatively connected to a third business object 124. The first business object 122 is in the logical deployment unit 141, the second business object 123 is in the logical deployment unit 142, and the third business object 124 is in the logical deployment unit 143.

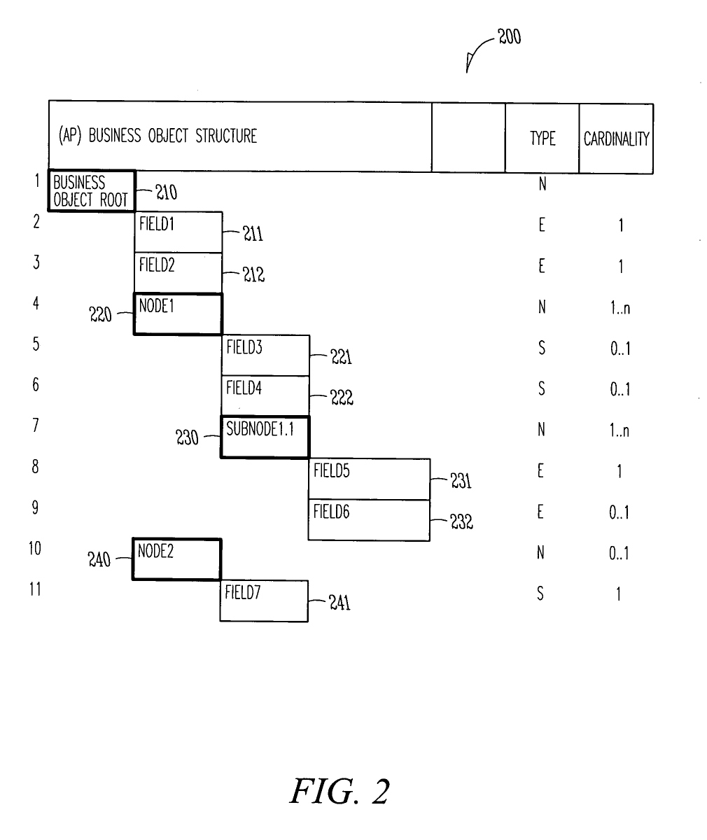

FIG. 2 is a display of a model 200 of a business object, such as business object 121, according to an example embodiment. A business object or object has a structure that includes a root 210, nodes such as nodes 220 and 240, and a sub node 230. Associated with a business or a root 210 is a grouping of information related to the business object root or root 210. Some of the information is held in fields such as 211 and 212. The information is also held in a node 220 which in turn also represents a grouping of information such as data and logic which are held in fields 221 and 222. Also under the root 210 and node 220 is a sub node 230. Sub node 230 holds another grouping of information that includes data and logic that are held in fields 231, 232. The business object 200 also includes another node 240. Node 240 is at the same level as node 220 and includes another grouping of data and logic which includes field 241. Therefore, it is seen that object 200 or business object 200 has a structure which includes a root 210, nodes, such as nodes 230 and 240, and sub nodes, such as sub node 230. It should be noted that FIG. 2 shows a simplified example of the structure of an object or business object 200. In actuality, a business object or object 200 may have a more complex structure. However, the principles as set forth in FIG. 2 will be followed where each root, node and/or sub node includes a grouping of information that can include data and logic.

In some embodiments, the structure of the business object or an outline of the business object is used to form a model of the business object 200. A model is useful for the purposes of designing and programming in a business object, such as business object 200. A model of the business object 200 shows the structure. In some embodiments, the model is referred to as a template. A template or model can take on any form just so it shows the structure of the object or business object 200. As shown in FIG. 2, the template is formed on a spreadsheet, such as an Excel spreadsheet. Excel is a registered trademark of Microsoft Corporation.

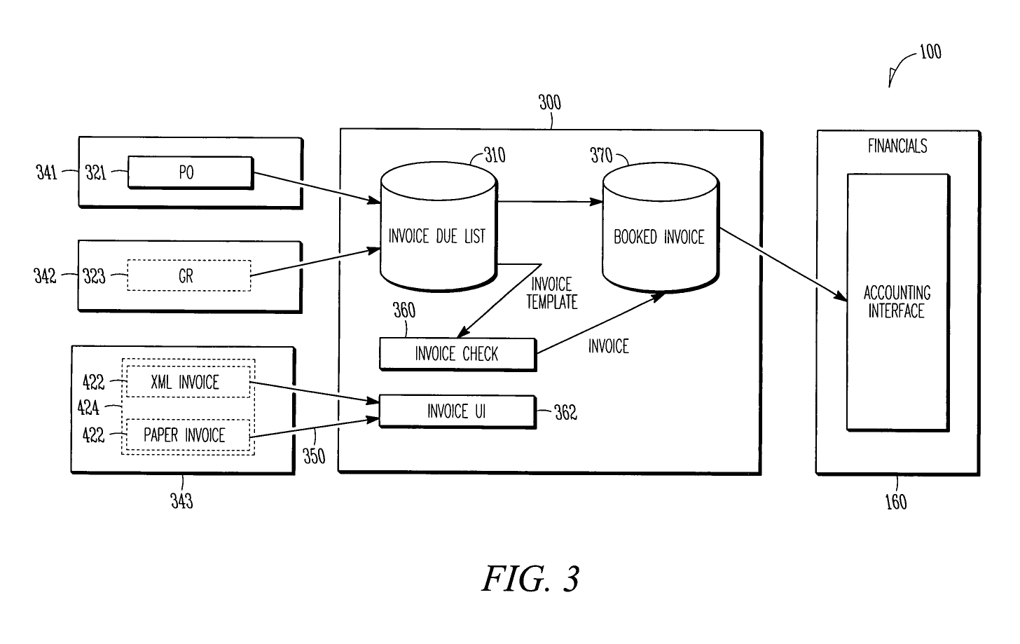

FIG. 3 is a schematic view of a portion of the computing environment 100 that includes a hub 300, according to an example embodiment. FIG. 3 is an example embodiment of the system 100 that includes a first business object 321 including a first source of information, a second business object 323 including a second source of information, and a hub 300 operatively connected to the first business object 321 and the second business object 323. The first business object 321 is in the logical deployment unit 341, the second business object 323 is in the logical deployment unit 342. The hub 300 collects information from the first source and the second source of information at a collection module 310. The hub 300 also includes an information checking module 360, a user interface 362, and a booked invoice database 370. The user interface 362 is coupled to the checking module 360, the invoice due list 310, the booked invoice database 370 and other parts of the hub 300. The information checking module 360 also has as an input, information from a third business object 324 is in the logical deployment unit 343. The information checking module 360 compares the information from the first business object 321 and the second business object 323 the information from the third business object 324, in one embodiment, is independent of the information associated with the first business object 321 and the second business object 323. Depending on whether or not the information from the first business object 321 and the second business object 323 compares to the information from the third business object 324 different actions can be taken. As shown in FIG. 3, the third source of information can include an image or an XML document portraying an image. The third source of information, in some embodiments, originates from a company external to the system 100.

FIG. 3 is discussed in general terms above. FIG. 3 is also a specific example embodiment of such a hub 300. In this particular example, the hub 300 is a central invoice hub 300. The first object is a purchase order business object 321, the second object is a goods received business object 323 and the third business object is an invoicing business object 424 that is part of a value chain 400 (discussed below). The invoicing business object 424 includes an original copy of the invoice 422, 422′ that is delivered to the checking module 360 of the invoice hub 300. The invoicing business object 424 delivers the original copy of the invoice 422, 422′ by way of the link 350.

The central invoice hub 300 also collects information from the first source and the second source of information at the collection module 310. In the example embodiment shown, this is an invoice due list 310 which includes the purchase order information from the purchase order business object 321, and includes the number of items received from the goods received business object 323. The purchase order business object 321 has the information regarding price to be paid for goods, and the number of items associated with the purchase order. The goods received business object 323 includes the actual number of items delivered or received. At the invoice checking module 360, the number of items actually received and the price paid are compared to the invoice 422 or 422′. If the quantities, prices, and amounts correspond and further possible checks are met, the invoice checking module 360 books the invoice or states that the invoice matches what was delivered in a data base 370 referred to as a booked invoice database. The booked invoice data base 370 is communicatively coupled to the accounting and financials component 160. If the number of items, the price or the amounts or any combination thereof do not correspond, or further possible checks are violated,at the invoice check module 360 do not correspond, the matter is resolved before sending an indication to the booked invoice database 370.

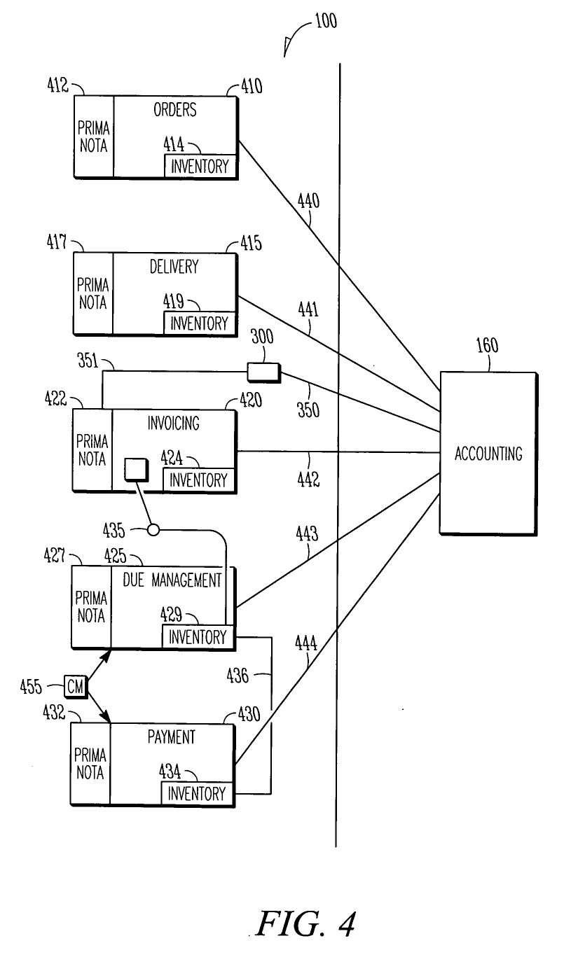

FIG. 4 is a block diagram illustration of a value chain 400 with prima nota and single point inventory business objects, according to an example embodiment. As mentioned above, the hub 300 and specifically the invoice checking module 360 receives invoice information from the third source of information. The invoice checking module 360, therefore, includes an interface for receiving invoice information from the third source of information. One of the business objects in the value chain 400 corresponds to a third business object that delivers a copy of the invoice to the central invoice hub 300.

Selected components in the value chain comprise an orders component, 410, a delivery component 415, an invoicing component 420, a due management component 425 and a payment component 430. Orders component 410 may include prima nota 412 and an order inventory object 414. The prima nota 412 consists of images of original business documents, such as actual customer orders and contracts in one embodiment. These are the original business documents, and in one embodiment, are assigned a unique internal identification or representation such as a string of numbers and/or characters, to ensure proper referencing. While such prima nota 412 are the primary business documents, copies of them may be provided if desired.

Order inventory object 414 may include an inventory of all current unshipped orders in one embodiment. It is updated by the use of messages generated as a result of transactions. A transaction may be performed by the orders component 410 in response to receipt of an order. A message to update the inventory object 414 may also result from a delivery transaction via delivery component 415.

Deliver component 415 may also include prima nota 417 that contains primary business documents, such as delivery documents, and a delivery inventory 419, which again may be updated via messages generated by transactions from one or more components.

Invoicing component 420 may also include prima nota 422 that contains primary copies of invoices and other business documents related to functions that the invoicing component 420 performs. Invoicing component 420 may also contain an inventory object 424 that contains a single point of inventory for invoices. The invoicing component 420 includes an output 351 that communicatively couples the prima nota portion 422 of the invoicing component 420 and the central invoicing hub 300. A link 350 links the central invoicing hub 300 to the accounting and financial component 160. The invoicing component 420 can, in some embodiments, be the third business object connected to the hub 300. The Transactions may result in increases and reductions in the inventory of inventory object 424.

Due management component 425 may also include prima nota 427, such as documents related to amounts due from business partners, collections notices, etc. Due management component 425 may also include a due inventory object that represents amounts due from business partners. It may be updated via messages resulting from transactions in various components, such as invoicing via the invoicing component as represented by line 435. It may also be updated by messages generated from payments received via payment component 430.

Payment component 430 may also include prima nota 432, such as documents related to payments. Payments may take many different forms, such as cash, check, money order, credit card, offsets, and electronic funds transfer. The prima nota may be scanned copies of checks, or associated communications with such payments. The payments are transactions that are processed by the payment component 430 and result in messages incrementing and decrementing a payment register inventory object 434.

In one embodiment, the components perform transactions that modify one or more inventory objects, and also may result in communications of such transactions in the form of messages as indicated at 440, 441, 442, 443 and 444 being sent to a separate accounting/finance system 160. The business operations 400 and accounting/finance system 160 are separate systems that communicate back and forth via messages. In one embodiment, the business operations system 400 is a cash based system, where cash is calculated in real time. The accounting system may operate on an accrual basis. By using messages between these two different systems, and keeping business documents and inventory separate in the operations system, each system is free to select how to handle transactions.

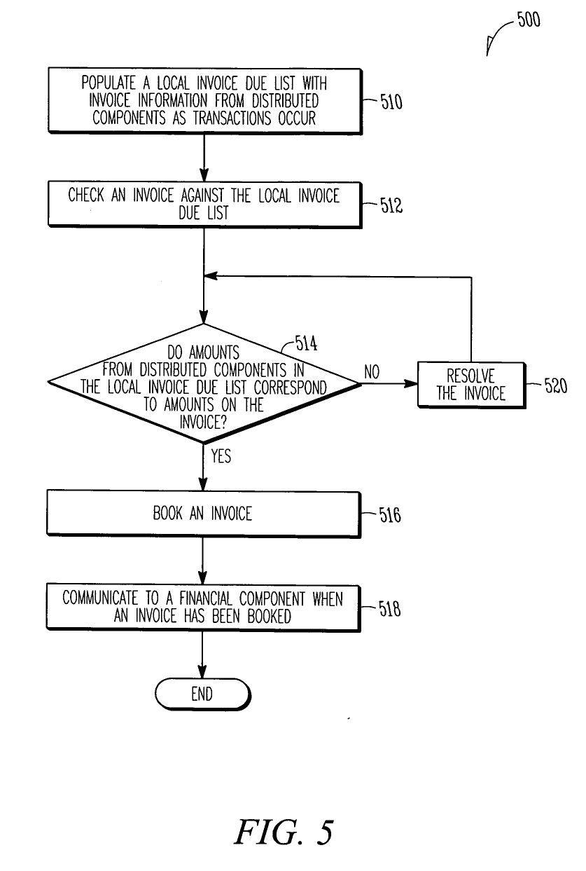

FIG. 5 is a flow diagram of a method 500 for checking invoices, according to an example embodiment. The method 500 of checking invoices includes populating a local invoice due list with invoice information from distributed components as transactions occur 510, and checking an invoice against the local invoice due list 512. The information or data in the local invoice due list is compatible with the format required by a local invoice checking process. The method also includes providing a selected interface to the local invoice due list, and matching the selected interface at each of the distributed components that populate the invoice due list. Populating the local invoice due list further includes populating the local invoice due list with a first portion of invoice information from a first object, and populating the local invoice due list with a second portion of invoice information from a second object. In some embodiments, populating the local invoice due list includes populating the local invoice due list with a delivery information portion from a delivery object, and populating the local invoice due list with a purchasing information portion from a purchasing object. Checking the invoice includes obtaining information from a third business object regarding the actual invoice. The amounts from the distributed components (the purchase order for price and number of items, and the actual goods recieved) are compared to the actual invoice at decision box 514. In the decision box 514, it is determined whether the number of items, the price or the amounts or any combination thereof and any further possible information from the distributed components in the local invoice due list correspond to the number of items, the price or the amounts or any combination thereof and any further possible information on the invoice. If the answer is yes, then the invoice is booked 516, and this action is communicated to the financial and accounting component of the system 518. If the number of items, the price or the amounts or any combination thereof and any further possible information from the distributed components in the local invoice due list do not correspond to the number of items, the price or the amounts or any combination thereof and any further possible information on the invoice, the invoice is resolved 520 and then placed into decision box 514 again. Once resolved, the invoice is booked 516 and this action is communicated to the accounting and financial component 518 and the process ends 522 for the selected invoice. Of course this process or method 500 can be generalized to compare a number of items, the price or the amounts or any combination thereof and any further possible information from any number of business objects to another business object.

The method 500, in some embodiments, also includes placing the invoice due list at a central invoice hub, and delivering an image of the invoice to a central invoice hub. In another embodiment, the invoice is delivered electronically to the central invoice hub. An invoice is booked 516 when the number of items, the price or the amounts or any combination thereof and any further possible information from the invoice information from distributed components in the local invoice due list correspond to number of items, the price or the amounts or any combination thereof and any further possible information on the invoice. The method 500, in some embodiments, also includes communicating to a financial component when an invoice has been booked. When the number of items, the price or the amounts or any combination thereof and any further possible information from the invoice information from distributed components in the local invoice due list fail to correspond to number of items, the price or the amounts or any combination thereof and any further possible information on the invoice, the invoice is set aside to be resolved 516. In some embodiments, resolving an invoice 516 includes communicating with the source of the invoice. In some embodiments, the method 500 includes providing a user interface for checking the invoice against the invoice due list.

A block diagram of a computer system 2000 that executes programming for performing the above algorithm is shown in FIG. 9, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A machine-readable medium including a set of instructions that, when executed by a machine, perform a method that includes enabling a change agent associated with a general business object 610, detecting a change in the general business object with the change agent 612, and creating a platform change document in a platform change business object in response to detecting a change in the general business object 614.

A machine-readable medium including a set of instructions that, when executed by a machine, perform the method that includes creating a platform change document in a platform change business object in response to detecting a change in a general business object 710, retrieving the general business object in a current state 712, applying a change associated with the platform change document from the platform change business object to the general business object to reconstruct the general business object in a historic state 714.

A computer readable medium having instructions for causing a computer to perform a method of checking invoices that includes populating a local invoice due list with invoice information from distributed components as transactions occur, and checking an invoice against the local invoice due list. The computer readable medium can also include instructions for implementing any or all of the other steps of the method 500 discussed above.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method of checking invoices comprising:
populating a local invoice due list with invoice information from distributed components as transactions occur; and
checking an invoice against the local invoice due list.

2. The method of claim 1 wherein data in the local invoice due list is compatible with the format required by a local invoice checking process.

3. The method of claim 1 further comprising:
providing a selected interface to the local invoice due list; and
matching the selected interface at each of the distributed components that populate the invoice due list.

4. The method of claim 1 wherein populating the local invoice due list further comprises:
populating the local invoice due list with a first portion of invoice information from a first object; and
populating the local invoice due list with a second portion of invoice information from a second object.

5. The method of claim 1 wherein populating the local invoice due list further comprises:
populating the local invoice due list with a delivery information portion from a delivery object;
populating the local invoice due list with a purchasing information portion from a purchasing object; and
comparing the delivery information portion from the delivery object to the purchasing information portion from the purchasing object.

6. The method of claim 1 further comprising:
placing the invoice due list at a central invoice hub; and
delivering an image of the invoice to a central invoice hub.

7. The method of claim 1 further comprising:
placing the invoice due list at a central invoice hub; and
delivering an electronic invoice to a central invoice hub.

8. The method of claim 1 further comprising booking an invoice when the amounts from the invoice information from distributed components in the local invoice due list correspond to amounts on the invoice.

9. The method of claim 8 further comprising communicating to a financial component when an invoice has been booked.

10. The method of claim 1 further comprising resolving an invoice when the amounts from the invoice information from distributed components in the local invoice due list fail to correspond to amounts on the invoice.

11. The method of claim 10 wherein resolving an invoice includes communicating with the source of the invoice.

12. The method of claim 1 further comprising providing a user interface for checking the invoice against the invoice due list.

13. A system comprising:
a first business object including a first source of information;
a second business object including a second source of information;
a hub operatively connected to the first business object and the second business object, the hub for collecting information from the first source and the second source of information; and
an information checking mechanism for comparing information from the first source and information from the second source with information from a third source independent from the first business object and the second business object.

14. The system of claim 13 wherein the third source of information includes an image.

15. The system of claim 13 wherein the third source of information originates from a company external to the system.

16. The system of claim 13 wherein the first source of information includes an a purchase order.

17. The system of claim 16 wherein the second source of information includes an indication of goods received.

18. The system of claim 17 wherein the third source of information includes an invoice.

19. The system of claim 18 wherein the hub further comprises an interface for receiving invoice information from the third source of information.

20. A computer readable medium having instructions for causing a computer to perform a method of checking invoices comprising:
populating a local invoice due list with invoice information from distributed components as transactions occur; and
checking an invoice against the local invoice due list.
